(19) United States
(12) Patent Application Publication
(10) Pub. No.: US 2023/0004528 A1
(43) Pub. Date: Jan. 5, 2023

(54) SYSTEMS AND METHODS FOR TEMPLATE-BASED DATA PROCESSING AND VISUALIZATION

(71) Applicant: Capital One Services, LLC, McLean, VA (US)

(72) Inventors: Saranya Thangaraj, Frisco, TX (US); Venkat Motupalli, Flower Mound, TX (US); Karthick Abiraman, Chennai (IN); Bing Liu, Frisco, TX (US); Dimas Gonzales, Dallas, TX (US); Anurag Andoji, Frisco, TX (US)

(21) Appl. No.: 17/363,699

(22) Filed: Jun. 30, 2021

(51) Int. Cl. G06F 16/16; G06F 9/451; G06F 3/0482; G06T 11/20

(52) U.S. Cl. CPC G06F 16/168; G06F 9/451; G06F 3/0482; G06T 11/206

(57) ABSTRACT

A system may comprise one or more processors, a memory in communication with the one or more processors, and storing instructions, that when executed by the one or more processors, are configured to cause the system to process and visualize data. The system may receive one or more data sets, and generate a plurality of templates, each template including one or more functions. The system may receive user input selecting a graphical representation for displaying the data sets. The system may process the data sets by utilizing a template. The system may generate one or more data files and cause a computing device to display the processed data sets as the graphical representation based on the data files. The system may retrieve one or more updated data files and cause the computing device to display the processed data sets as an updated graphical representation based on the updated data files.

### FIELD OF INVENTION

The present disclosure relates to systems and methods for template-based data processing and visualization, and more particularly to template-based systems and methods for processing data and displaying data as various graphical representations.

### BACKGROUND

Traditional systems and methods for processing and visualizing data require manual code changes each time a user wishes to add data to an existing data set, and each time a user wishes to display a set of data as a different graphical representation. These systems and methods can be quite cumbersome and inefficient, especially when dealing with large and/or numerous sets of data, or when working with data that updates routinely, such as on a weekly, monthly, or quarterly basis. Further, these systems and methods require sequential processing of individual graphical representations, which leads to poor computation efficiency.

Accordingly, there is a need for systems and methods that do not require manual code changes when processing data or displaying the data in different graphical representations, and that can provide enhanced processing efficiency. Embodiments of the present disclosure are directed to this and other considerations.

### SUMMARY

Disclosed embodiments provide systems and methods for template-based data processing and visualization that do not require manual code changes at either the processing or visualization steps.

Consistent with the disclosed embodiments, a system may include one or more processors and a memory in communication with the one or more processors and storing instructions, that when executed by the one or more processors, are configured to cause the system to perform a method for processing and visualizing one or more data sets. For example, the system (e.g., a data visualization system) may receive one or more sets of data (e.g., loan application data). The system may generate a plurality of processing templates, wherein each of the plurality of processing templates comprising one or more pre-coded functions (e.g., aggregate, combine columns, calculate weighted average, etc.). The system may receive a first user input (e.g., via a dropdown selector on a graphical user interface (GUI) of a computing device) selecting a first graphical representation (e.g., a bar graph, line graph, pie chart, etc.) for displaying the one or more data sets. The system may retrieve, based on the first user input, a first template of the plurality of processing templates. The system may then process the one or more data sets by utilizing the first template. The system may generate one or more data files (e.g., raw data file, configuration file, directory file, etc.) corresponding to the one or more processed data sets. The system may cause a computing device (e.g., a mobile phone, laptop, tablet, etc.) to display, via a GUI, the one or more processed data sets as the first graphical representation based on the one or more data files. The system may retrieve one or more updated data files (e.g., comprising one or more modifications and/or additions to the one or more data sets) corresponding to the one or more processed data sets. In some embodiments, the system may retrieve the one or more updated data files based on a request from the computing device to update the first graphical representation. The system may then cause the computing device to display, via the GUI, the one or more processed data sets as a second graphical representation based on the one or more updated data files. The disclosed embodiments provide the benefits of not only receiving user input as to the type of graphical representation for displaying the data, but also allowing automatic updating of that graphical representation when the system recognizes changes to the existing data sets.

Other embodiments allow for the benefit of increased user input for switching between types of graphical representations. In one such embodiment, after receiving one or more data sets, and generating a plurality of processing templates, the system may retrieve a first template of the plurality of processing templates, wherein the first template comprises a default graphical representation (e.g., a bar graph, line graph, pie chart, etc.) for displaying the one or more data sets. The system may process the one or more data sets by utilizing the first template. The system may cause a computing device to display, e.g., via a GUI, the one or more data sets as the default graphical representation. The system may then receive a first user input selecting a second graphical representation for displaying the one or more data sets. The system may retrieve, based on the first user input, a second template of the plurality of processing templates. The system may process the one or more data sets by utilizing the second template. The system may then cause the computing device to display, via the GUI, the one or more data sets as the second graphical representation. In some embodiments, the second graphical representation may be different from the default graphical representation such that a user may visualize the data in different graphical forms. In such embodiments, the second template may be different from the first template, i.e., the first and second templates may comprise one or more different and respective pre-coded functions for processing the data and enabling the computing device to display the data as the default and second graphical representations, respectively.

In another such embodiment, after receiving one or more data sets, the system may generate a plurality of processing templates, wherein each of the plurality of processing templates corresponds to a type of graphical representation for displaying data. The system may receive a first user input selecting a first graphical representation (e.g. a line graph) for displaying the one or more data sets. The system may process the one or more data sets by utilizing a first template of the plurality of processing templates. The system may then cause a computing device to display, e.g., via a GUI, the one or more data sets as the first graphical representation. Next, the system may receive a second user input selecting a second graphical representation (e.g., a scatter plot) for displaying the one or more data sets. The system may process the one or more data sets by utilizing a second template of the plurality of processing templates. They system may then cause the computing device to display, via the GUI, the one or more data sets as the second graphical representation. As described above, in some embodiments, the first template may be different from the second template.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which are incorporated into and constitute a portion of this disclosure, illustrate various implementations and aspects of the disclosed technology and, together with the description, serve to explain the principles of the disclosed technology. In the drawings:

FIG. 1 is a diagram of an example system environment that may be used to implement one or more embodiments of the present disclosure;

FIG. 2 is a component diagram of a data visualization system in accordance with some embodiments of the present disclosure;

FIG. 3 is a component diagram of a computing device in accordance with some embodiments of the present disclosure;

FIG. 4 is a flowchart of a method for template-based data processing and visualization in accordance with some embodiments of the present disclosure;

FIG. 5 is a flowchart of a method for template-based data processing and visualization in accordance with some embodiments of the present disclosure; and

FIG. 6 is a flowchart of a method for template-based data processing and visualization in accordance with some embodiments of the present disclosure.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

By way of introduction, aspects discussed herein may relate to systems and methods for template-based processing and visualization of data. For example, some embodiments describe processing one or more sets of data by utilizing templates comprising one or more pre-coded functions. Some embodiments also describe visualizing the one or more sets of data by enabling a computing device to display the data as different graphical representations. These provide advantages over other systems and methods by improving efficiency in being able to update existing sets of data and/or switch between various graphical representations without the need for manual code changes in either the processing or visualization steps. Further, whereas other systems and methods require sequential processing of individual graphical representations, the enclosed systems and methods provide improved computation efficiency in that a template-based approach allows for parallel processing of data groups. That is, one function coded in a single template may be capable of processing different data components simultaneously. As such, the following discussion describes several exemplary systems and methods for template-based processing and visualization of data.

Reference will now be made in detail to example embodiments of the disclosed technology, examples of which are illustrated in the accompanying drawings and disclosed herein. Wherever convenient, the same references numbers will be used throughout the drawings to refer to the same or like parts.

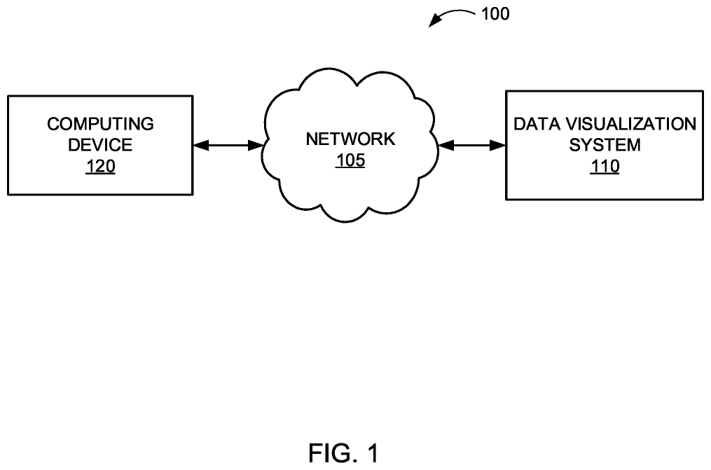

FIG. 1 is a diagram of an example system environment that may be used to implement one or more embodiments of the present disclosure. The components and arrangements shown in FIG. 1 are not intended to limit the disclosed embodiments as the components used to implement the disclosed processes and features may vary.

In accordance with disclosed embodiments, system 100 may include a data visualization system 110 in communication with a computing device 120 via network 105. In some embodiments, data visualization system 110 may also be in communication with various databases. Computing device 120 may be a user device such as a mobile computing device (e.g., a smart phone, tablet computer, smart wearable device, portable laptop computer, voice command device, wearable augmented reality device, or other mobile computing device) or a stationary device (e.g., desktop computer).

In some embodiments, the computing device 120 may provide an input to the data visualization system 110 selecting a type of graphical representation for displaying one or more sets of data. The data visualization system 110 may, based on the input, process the one or more sets of data utilizing a template corresponding to the selected graphical representation, and then cause computing device 120 to display the one or more sets of data as the selected graphical representation.

Network 105 may be of any suitable type, including individual connections via the internet such as cellular or WiFi networks. In some embodiments, network 105 may connect terminals using direct connections such as radio-frequency identification (RFID), near-field communication (NFC), Bluetooth™, low-energy Bluetooth™ (BLE), WiFi™, ZigBee™, ambient backscatter communications (ABC) protocols, USB, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

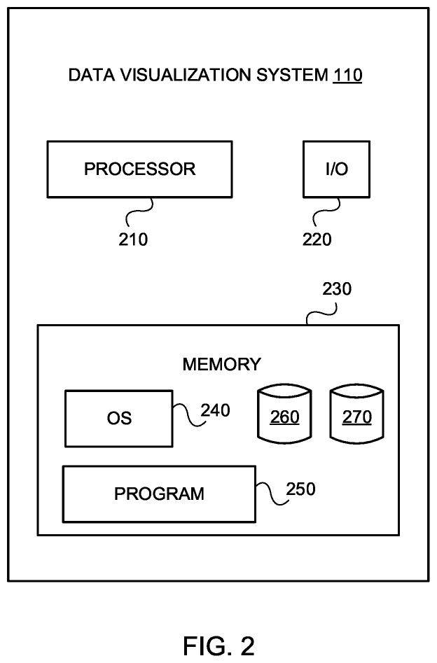

An example embodiment of data visualization system 110 is shown in more detail in FIG. 2. Computing device 120 may have a similar structure and components that are similar to those described with respect to data visualization system 110. As shown, data visualization system 110 may include a processor 210, an input/output (“I/O”) device 220, a memory 230 containing an operating system (“OS”) 240 and a program 250. For example, data visualization system 110 may be a single server or may be configured as a distributed computer system including multiple servers or computers that interoperate to perform one or more of the processes and functionalities associated with the disclosed embodiments. In some embodiments, data visualization system 110 may further include a peripheral interface, a transceiver, a mobile network interface in communication with processor 210, a bus configured to facilitate communication between the various components of data visualization system 110, and a power source configured to power one or more components of data visualization system 110.

A peripheral interface may include the hardware, firmware and/or software that enables communication with various peripheral devices, such as media drives (e.g., magnetic disk, solid state, or optical disk drives), other processing devices, or any other input source used in connection with the instant techniques. In some embodiments, a peripheral interface may include a serial port, a parallel port, a general-purpose input and output (GPIO) port, a game port, a universal serial bus (USB), a micro-USB port, a high definition multimedia (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), NFC, Bluetooth™ low-energy Bluetooth™ (BLE), WiFi™, ZigBee™, ambient backscatter communications (ABC) protocols or similar technologies.

A mobile network interface may provide access to a cellular network, the Internet, or another wide-area network. In some embodiments, a mobile network interface may include hardware, firmware, and/or software that allows processor(s) 210 to communicate with other devices via wired or wireless networks, whether local or wide area, private or public, as known in the art. A power source may be configured to provide an appropriate alternating current (AC) or direct current (DC) to power components.

As described above, data visualization system 110 may be configured to remotely communicate with one or more other devices, such as computing device 120.

Processor 210 may include one or more of a microprocessor, microcontroller, digital signal processor, co-processor or the like or combinations thereof capable of executing stored instructions and operating upon stored data. Memory 230 may include, in some implementations, one or more suitable types of memory (e.g., volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like) for storing files, including an operating system, application programs (including, e.g., a web browser application, a widget or gadget engine, or other applications, as necessary), executable instructions, and data. In one embodiment, the processing techniques described herein are implemented as a combination of executable instructions and data within the memory 230.

Processor 210 may be one or more known processing devices, such as a microprocessor from the Pentium™ family manufactured by Intel™ or the Turion™ family manufactured by AMD™. Processor 210 may constitute a single core or multiple core processor that executes parallel processes simultaneously. For example, processor 210 may be a single core processor that is configured with virtual processing technologies. In certain embodiments, processor 210 may use logical processors to simultaneously execute and control multiple processes. Processor 210 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

Data visualization system 110 may include one or more storage devices configured to store information used by processor 210 (or other components) to perform certain functions related to the disclosed embodiments. In one example, data visualization system 110 may include memory 230 that includes instructions to enable processor 210 to execute one or more applications, such as server applications, network communication processes, and any other type of application or software known to be available on computer systems. Alternatively, the instructions, application programs, etc., may be stored in an external storage or available from a memory over a network. The one or more storage devices may be a volatile or non-volatile, magnetic, semiconductor, tape, optical, removable, non-removable, or other type of storage device or tangible computer-readable medium.

In one embodiment, data visualization system 110 may include memory 230 that includes instructions that, when executed by processor 210, perform one or more processes consistent with the functionalities disclosed herein. Methods, systems, and articles of manufacture consistent with disclosed embodiments are not limited to separate programs or computers configured to perform dedicated tasks. For example, data visualization system 110 may include memory 230 that may include one or more programs 250 to perform one or more functions of the disclosed embodiments. Moreover, processor 210 may execute one or more programs 250 located remotely from data visualization system 110. For example, data visualization system 110 may access one or more remote programs 250, that, when executed, perform functions related to disclosed embodiments.

Memory 230 may include one or more memory devices that store data and instructions used to perform one or more features of the disclosed embodiments. Memory 230 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational databases. Memory 230 may include software components that, when executed by processor 210, perform one or more processes consistent with the disclosed embodiments. In some embodiments, memory 230 may include a file database 260 and a template database 270 for storing related data to enable data visualization system 110 to perform one or more of the processes and functionalities associated with the disclosed embodiments.

Data visualization system 110 may also be communicatively connected to one or more memory devices (e.g., databases (not shown)) locally or through a network. The remote memory devices may be configured to store information and may be accessed and/or managed by data visualization system 110. By way of example, the remote memory devices may be document management systems, Microsoft™ SQL database, SharePoint™ databases, Oracle™ databases, Sybase™ databases, or other relational databases. Systems and methods consistent with disclosed embodiments, however, are not limited to separate databases or even to the use of a database.

Data visualization system 110 may also include one or more I/O devices 220 that may include one or more interfaces for receiving signals or input from devices and providing signals or output to one or more devices that allow data to be received and/or transmitted by data visualization system 110. For example, data visualization system 110 may include interface components, which may provide interfaces to one or more input devices, such as one or more keyboards, mouse devices, touch screens, track pads, trackballs, scroll wheels, digital cameras, microphones, sensors, and the like, that enable data visualization system 110 to receive data from one or more users (such as via computing device 120).

In example embodiments of the disclosed technology, data visualization system 110 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

While data visualization system 110 has been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations may include a greater or lesser number of components than those illustrated.

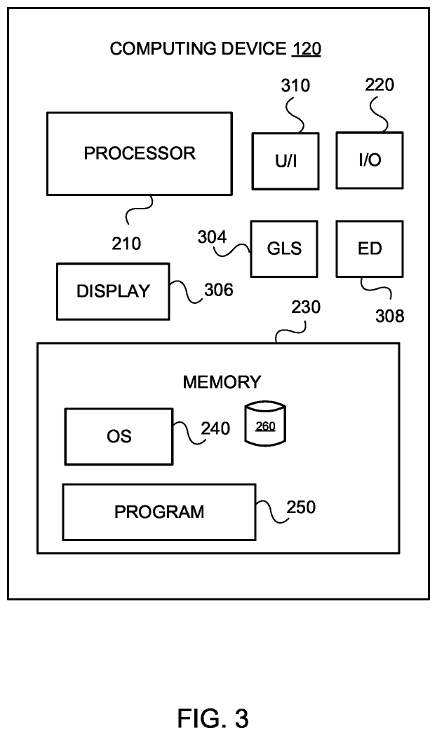

FIG. 3 shows an example embodiment of computing device 120. As shown, computing device 120 may include I/O device 220 for receiving data from another device (e.g., data visualization system 110), memory 230 containing OS 240, program 250, and any other associated component as described above with respect to data visualization system 110. Computing device 120 may also have one or more processors 210, a geographic location sensor (“GLS”) 304 for determining the geographic location of computing device 120, a display 306 for displaying content such as text messages, images, and selectable buttons/icons/links, an environmental data (“ED”) sensor 308 for obtaining environmental data including audio and/or visual information, and a user interface (“U/I”) device 310 for receiving user input data, such as data representative of a click, a scroll, a tap, a press, or typing on an input device that can detect tactile inputs. User input data may also be non-tactile inputs that may be otherwise detected by ED sensor 308. For example, user input data may include auditory commands. According to some embodiments, U/I device 310 may include some or all of the components described with respect to I/O device 220 above. In some embodiments, environmental data sensor 308 may include a microphone and/or an image capture device, such as a digital camera.

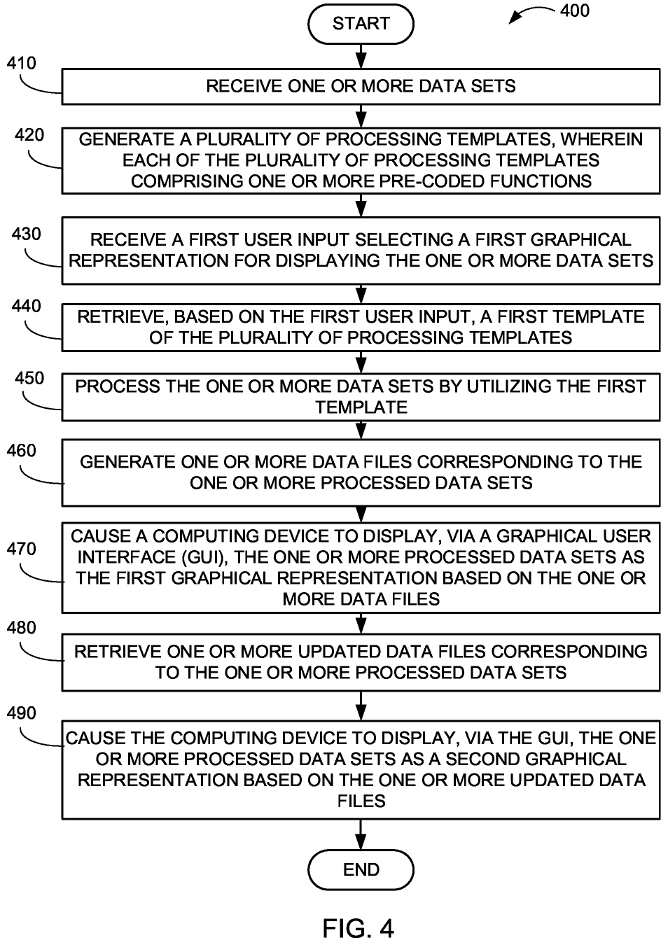

FIG. 4 shows a flowchart of a method 400 for performing template-based data processing and visualization. Method 400 may be performed by the data visualization system 110 and/or the computing device 120 of the system 100. This embodiment provides the benefit of enabling a user to visualize data in graphical form as the data may be changing in real-time, without the user or the system itself having to make any code changes during either the processing or visualization steps.

In block 410, the system (e.g., system 100) may receive one or more data sets. For example, system 100 may receive one or more sets of financial data, such as loan application data, that may comprise, e.g., tax data, income data, and/or bankruptcy data. System 100 may be configured to receive the one or more data sets at some given frequency, such as on a daily, weekly, monthly, or quarterly basis. System 100 may also be configured to store the one or more data sets in one or more databases.

In block 420, the system (e.g., system 100) may generate a plurality of processing templates, wherein each of the plurality of processing templates comprising one or more pre-coded functions for processing data such that the data may be displayed as a certain type of graphical representation. The plurality of processing templates may be indexed such that the system may easily retrieve the most appropriate template for processing a set of data. The one or more pre-coded functions may be, for example, aggregate, combine versions, combine values, select columns, combine columns, generate configuration, plot directory, pre-process, post-process, select source, split data, create subset rows, calculate weighted average, filter, transpose, output, or combinations thereof. Each of these pre-coded functions defines a way in which system 100 may process one or more data sets. That is, the function “aggregate” informs system 100 to combine or group together one or more data sets; “combine versions” informs system 100 to combine or consolidate different versions of one or more data sets; “combine columns” informs system 100 to combine or consolidate one or more data sets written in column format; “generate configuration” informs system 100 to generate one or more configuration data files comprising metadata associated with one or more data sets; “plot directory” informs system 100 to generate one or more directory files for one or more data sets for logical grouping of the one or more data sets; “pre-process” informs system 100 to prepare one or more data sets for processing; “post-process” informs system 100 to edit or organize one or more data sets after processing; “select source” informs system 100 to identify from where one or more data sets come; “split data’ informs system 100 to divide one or more data sets into smaller segments; “create subset rows” informs system 100 to create rows of one or more data sets comprising sub-groupings or sub-categories within each row; “calculate weighted average” informs system 100 to calculate the weighted average of one or more data sets; “filter” informs system 100 to select a smaller set of one or more data sets for evaluation; “transpose” informs system 100 to rotate one or more data sets from rows to columns or vice versa; “output” informs system 100 to output or produce one or more processed data sets.

The one or more pre-coded functions may also comprise one or more pre-coded sub-functions which may each further define how system 100 may process or perform the one or more pre-coded functions. For example, pre-coded function “generate configuration” may comprise one or more pre-coded sub-functions to inform system 100 which types of metadata to include in the one or more configuration files, e.g., an x-axis, a y-axis, type of graph, title of graph, area of graph, colors of graph, etc.

In block 430, the system (e.g., system 100) may receive a first user input selecting a first graphical representation as a criteria for displaying the one or more data sets. For example, a user may operate a computing device (e.g., computing device 120) and may select a type of graphical representation via, e.g., a dropdown selector provided on a GUI of computing device 120. The user may select from among many types of graphical representations, such as a bar graph, a line graph, a scatter plot, a chart, a pie chart, a dot plot, a histogram, or the like. Each of the types of graphical representations provides a means of visualizing the one or more data sets.

In block 440, the system (e.g., system 100) may retrieve, based on the first user input, a first template of the plurality of processing templates. That is, without having to perform or undergo any code change, system 100 may determine which template, i.e., which grouping of one or more pre-coded functions and sub-functions, will enable system 100 to most accurately process the one or more data sets and provide for visualization of the one or more data sets based on the user's selected first graphical representation criteria by looking to the previously defined processing template index. For example, if a user selects a line graph as the first graphical representation, system 100 may determine that a first template best corresponds to processing and displaying the one or more data sets as a line graph, and may automatically retrieve the first template based on that determination.

In block 450, the system (e.g., system 100) may process the one or more data sets by utilizing the first template. That is, system 100 may process the one or more data sets according to the one or more pre-coded functions and sub-functions included in the first template.

In block 460, the system (e.g., system 100) may generate one or more data files corresponding to the one or more processed data sets. The one or more data files may comprise one or more comma-separated values (CSV) files for storing the one or more processed data sets. The one or more data files may also comprise one or more configuration files, e.g., a .json file, for storing metadata associated with the one or more processed data sets. For example, a configuration file may contain metadata such as an x-axis, a y-axis, type of graph, title of graph, area of graph, colors of graph, etc. The one or more data files may also comprise one or more directory files, e.g., a .json file, used for performing logical grouping of the one or more processed data sets. That is, the one or more directory files may enable system 100 to logically group the one or more data sets according to type of graphical representation.

In block 470, the system (e.g., system 100) may cause a computing device (e.g., computing device 120) to display, e.g., via a GUI, the one or more processed data sets as the first graphical representation based on the one or more data files. That is, system 100 may transmit the one or more data files, containing the one or more processed data sets, metadata corresponding to the one or more processed data sets, and the one or more directory files associated with the one or more processed data sets, to computing device 120 via, e.g., an application programming interface (API). Computing device 120 may then display the one or more processed data sets via a user interface as the first graphical representation.

In block 480, the system (e.g., system 100) may retrieve one or more updated data files corresponding to the one or more processed data sets. That is, system 100 may recognize that the one or more data sets have been modified and/or that additional data has been added to the one or more data sets. Without having to perform or undergo any code change, system 100 may automatically retrieve one or more updated data files, and re-process the one or more data sets by utilizing the first template but based on the one or more updated data files.

In block 490, the system (e.g., system 100) may cause a computing device (e.g., computing device 120) to display, e.g., via a GUI, the one or more processed data sets as a second graphical representation based on the one or more updated data files. That is, system 100 may transmit the one or more updated data files, containing one or more modifications to the one or more processed data sets, the metadata corresponding to the one or more processed data sets, and/or the one or more directory files associated with the one or more processed data sets, to computing device 120 via an API. Computing device 120 may then display the one or more processed data sets as a second graphical representation based on the one or more updated data files.

In some embodiments, the second graphical representation may be an updated version of the first graphical representation which replaces the first graphical representation via the GUI. That is, both the first and second graphical representations may be, e.g., bar graphs, yet the second graphical representation is an updated or refreshed version of the first graphical representation. In some embodiments, as soon as system 100 receives new data, system 100 may automatically transmit the new data to computing device 120 to cause computing device 120 to automatically refresh or update the first graphical representation as the second graphical representation via the GUI. This dynamic process may occur many times with a third graphical representation replacing the second graphical representation and a fourth graphical representation replacing a third graphical representation, and so on. In some embodiments, a user may wish to have computing device 120 display the one or more processed data sets, based on the one or more updated files, as a second graphical representation different from the first graphical representation. That is, the first graphical representation may be, e.g., a bar graph, and the second graphical representation may be, e.g., a scatter plot. In that case, system 100 may re-process the one or more data sets based on the one or more updated data files yet by utilizing a second template different from the first template. That is, system 100 may automatically recognize that a second template is required for re-processing the one or more data sets according to a different one or more pre-coded functions (and sub-functions) located in the second template, to display the one or more data sets as the second graphical representation.

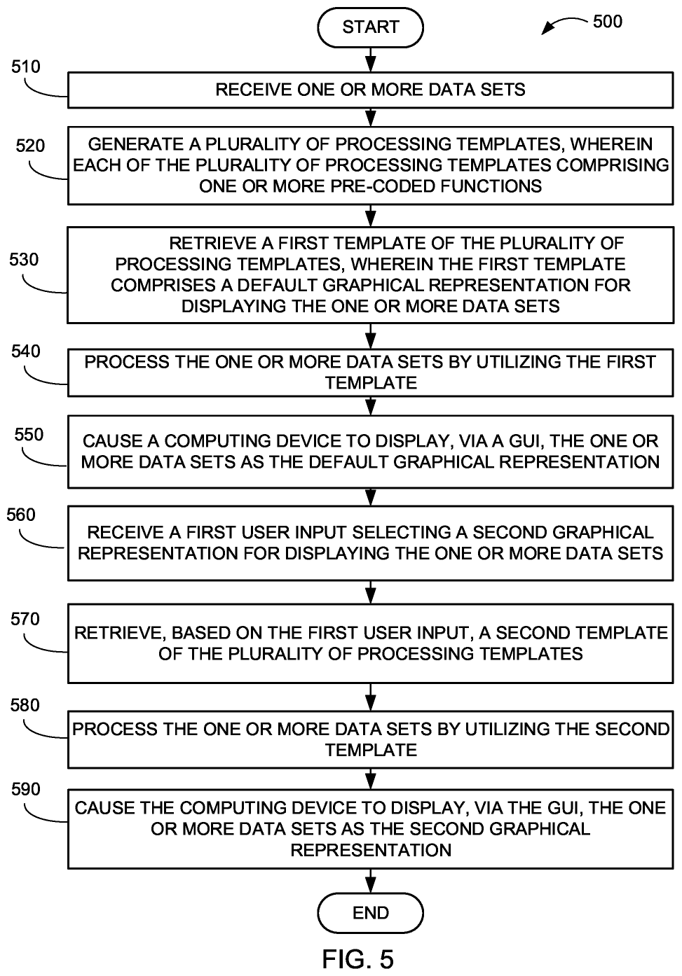

FIG. 5 shows a flowchart of a method 500 for performing template-based data processing and visualization. Method 500 may also be performed by the data visualization system 110 and/or the computing device 120 of the system 100. Method 500 is similar to method 400 except that method 500 involves first displaying one or more data sets as a default graphical representation, prior to receiving any user input for selection of a second or different graphical representation. This embodiment provides the added benefit of providing a user with a starting point for how data may be best visualized through a graphical form; however, also enables the user to choose whether to stick with the default form, or switch to another. And similar to method 400 in FIG. 4, method 500 may also be performed without the user or the system itself having to make any code changes during either the processing or visualization steps.

In block 510, the system (e.g., system 100) may receive one or more data sets, as previously described in block 410 of FIG. 4.

In block 520, the system (e.g., system 100) may generate a plurality of processing templates, wherein each of the plurality of processing templates comprising one or more pre-coded functions, as previously described in block 420 of FIG. 4.

In block 530, the system (e.g., system 100) may retrieve a first template of the plurality of processing templates, wherein the first template comprises a default graphical representation for displaying the one or more data sets. The default graphical representation may be any type of graphical representation, such as a bar graph, a line graph, a scatter plot, a chart, a pie chart, a dot plot, a histogram, or the like. Each of the types of graphical representations provides a means of visualizing the one or more data sets.

In block 540, the system (e.g., system 100) may process the one or more data sets by utilizing the first template, as previously discussed in block 450 of FIG. 4.

In block 550, the system (e.g., system 100) may cause a computing device (e.g., computing device 120) to display, e.g., via a GUI, the one or more data sets as the default graphical representation. That is, absent any user input, system 100 may automatically transmit the one or more data sets to computing device 120 via, e.g., an API, such that computing device 120 may then display the one or more data sets as the default graphical representation.

In block 560, the system (e.g., system 100) may receive a first user input selecting a second graphical representation as a criteria for displaying the one or more data sets. Similar to block 430 of FIG. 4, a user may operate a computing device (e.g., computing device 120) and may select a type of graphical representation via, e.g., a dropdown selector provided on a GUI of computing device 120. The user may select from among many types of graphical representations, such as a bar graph, a line graph, a scatter plot, a chart, a pie chart, a dot plot, a histogram, or the like. Each of the types of graphical representations provides a means of visualizing the one or more data sets. In some embodiments, the second graphical representation may be a different type of graphical representation from the default graphical representation, such that the user may visualize the one or more data sets in multiple ways.

In block 570, the system (e.g., system 100) may retrieve, based on the first user input, a second template of the plurality of processing templates, as previously discussed in block 440 of FIG. 4. In block 570, system 100, without having to perform or undergo any code change, may determine a second template as including the one or more pre-coded functions and sub-functions to enable system 100 to most accurately process the one or more data sets and provide for visualization of the one or more data sets based on the user's selected second graphical representation criteria. For example, if a user selects a pie chart as the second graphical representation, system 100 may determine that a second template best corresponds to processing and displaying the one or more data sets as a pie chart, and may automatically retrieve the second template based on that determination.

In block 580, the system (e.g., system 100) may process the one or more data sets by utilizing the second template, as previously described with respect to the first template utilized in block 450 of FIG. 4. In block 580, however, the second template may be different from the first template, such that the second template better helps to inform system 100 how to process the one or more data sets for display as the second graphical representation. That is, system 100 may automatically recognize that a second template is required for processing the one or more data sets according to a different one or more pre-coded functions (and sub-functions) located in the second template, to display the one or more data sets as a second graphical representation.

In block 590, the system (e.g., system 100) may cause the computing device (e.g., computing device 120) to display, e.g., via a GUI, the one or more data sets as the second graphical representation. That is, system 100 may automatically transmit the one or more data sets to computing device 120 via, e.g., an API, such that computing device 120 may then display the one or more data sets as the second graphical representation, replacing the default graphical representation.

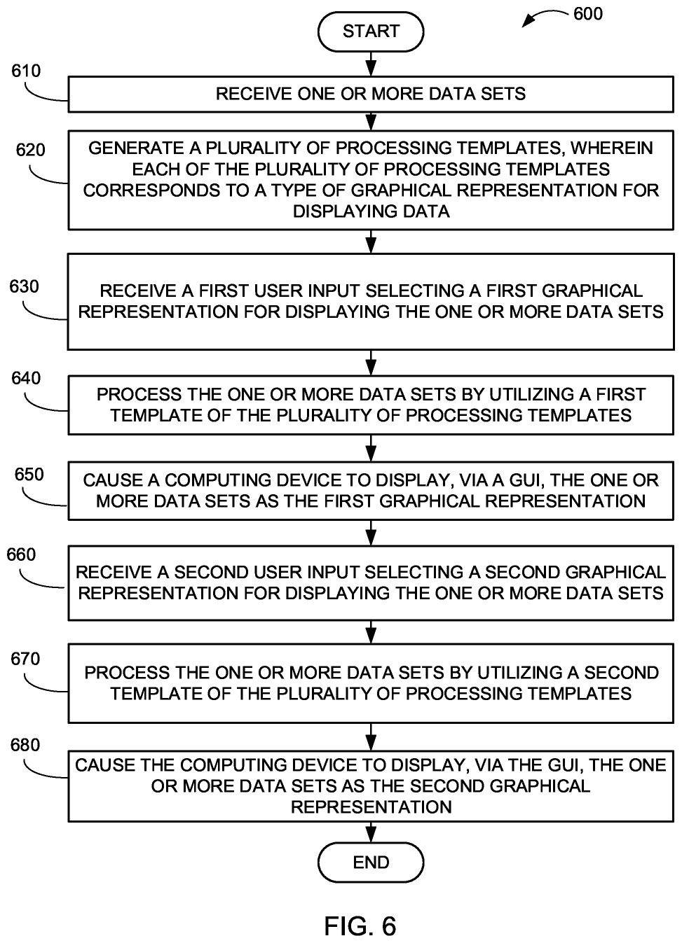

FIG. 6 shows a flowchart of a method 600 for performing template-based data processing and visualization. Method 600 may also be performed by the data visualization system 110 and/or the computing device 120 of the system 100. Method 600 is similar to method 400 except that method 600 involves receiving a second user input for selection of a second or different graphical representation for displaying one or more data sets after first receiving a first user input for selection of a first graphical representation for displaying the one or more data sets. This embodiment provides the added benefit of allowing a user to easily switch between graphical representation types such that the user may visualize the data in different ways. And similar to method 400 of FIG. 4 and method 500 of FIG. 5, the user can make these switches efficiently without the user or the system itself needing to make any code changes during either the processing or visualization steps.

In block 610, the system (e.g., system 100) may receive one or more data sets, as previously described in block 410 of FIG. 4.

In block 620, the system (e.g., system 100) may generate a plurality of processing templates, wherein each of the plurality of processing templates corresponds to a type of graphical representation for displaying data. That is, each template helps to inform system 100 how to accurately and efficiently process one or more data sets to enable a computing device to display the one or more data sets as a specific type of graphical representation. In some embodiments, as previously described with respect to block 420 of FIG. 4, each of the plurality of processing templates may comprise one or more pre-coded functions, each helping to inform system 100 how to process one or more data sets. In some embodiments, as previously described, the one or more pre-coded functions may also comprise one or more pre-coded sub-functions that help to further define each of the one or more pre-coded functions.

In block 630, the system (e.g., system 100) may receive a first user input selecting a first graphical representation as a criteria for displaying the one or more data sets, as previously described in block 430 of FIG. 4.

In block 640, the system (e.g., system 100) may process the one or more data sets by utilizing a first template of the plurality of processing templates, as previously described in block 450 of FIG. 4. In utilizing the first template, system 100 may determine that the first template enables system 100 to most accurately process the one or more data sets and provide for visualization of the one or more data sets based on the user's selected first graphical representation criteria.

In block 650, the system (e.g., system 100) may cause a computing device (e.g., computing device 120) to display, e.g., via a GUI, the one or more data sets as the first graphical representation. That is, system 100 may automatically transmit the one or more data sets to computing device 120 via, e.g., an API, such that computing device 120 may then display the one or more data sets as the first graphical representation.

In block 660, the system (e.g., system 100) may receive a second user input selecting a second graphical representation as a criteria for displaying the one or more data sets, as previously described with respect to the first user input in block 430 of FIG. 4. The difference in block 660, however, is that system 100 may now receive a second user input, separate from the prior received first user input. Like the first user input, the second user input may comprise a user operating a computing device (e.g., computing device 120); however, the user this time may select a second type of graphical representation via, e.g., a dropdown selector provided on a GUI of computing device 120. The user may select from among many types of graphical representations, such as a bar graph, a line graph, a scatter plot, a chart, a pie chart, a dot plot, a histogram, or the like. In some embodiments, the second graphical representation may be different from the first graphical representation. For example, if the first user input selected a bar graph for displaying the one or more data sets, the second user input may select a scatter plot for displaying the one or more data sets.

In block 670, the system (e.g., system 100) may process the one or more data sets by utilizing a second template of the plurality of processing templates, as previously described with respect to the first template utilized in block 450 of FIG. 4. In block 670, however, the second template may be different from the first template. That is, in utilizing the second template, system 100 may determine that the second template enables system 100 to most accurately process the one or more data sets and provide for visualization of the one or more data sets based on the user's selected second graphical representation criteria.

In block 680, the system (e.g., system 100) may cause a computing device (e.g., computing device 120) to display, e.g., via a GUI, the one or more data sets as the second graphical representation. That is, system 100 may automatically transmit the one or more data sets to computing device 120 via, e.g., an API, such that computing device 120 may then display the one or more data sets as the second graphical representation, replacing the previously selected first graphical representation. As previously described, in some embodiments, the second graphical representation may be different from the first graphical representation such that the user may visualize the one or more data sets in different graphical forms.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above with reference to user devices that may include mobile computing devices. Those skilled in the art will recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### Example Use Cases

The following example use cases describe examples of a typical user flow pattern. They are intended solely for explanatory purposes and not in limitation.

In one example, a system may receive one or more sets of data. The system may first code and generate a set of templates, each template including a set of functions for processing the data. For example, one template may include the functions of aggregate, combine versions, combine evaluations, generate configuration, plot directory, select columns, split data, generate subset rows, and calculate weighted average. Each of these functions may also include one or more sub-functions for additional processing of the data within each function. Once a set of templates is generated, a user may access the system to visualize the data, i.e., to view the data as a graphical representation. For example, a user may use a computing device, e.g., a mobile phone, to access a mobile application. Through the application, the user may select a type of graphical representation, e.g., a bar graph, for displaying the data. Once the user has selected the bar graph via, for example, a dropdown selector displayed on a GUI of the mobile phone, the system may receive the user selection and may retrieve a first template appropriate for processing the data and displaying the data as a bar graph. The system may then process the data according to the series of functions and sub-functions coded in the first template. Once the system has processed the data, it may generate a set of files, e.g., a data file for storing the processed data, and a configuration file for storing the metadata associated with the processed data. The system may then cause the mobile phone to display, e.g., via a GUI, the processed data in the form of a bar graph based on the generated set of files. The system may then recognize that there have been one or more modifications and/or additions made to the data, such as the addition of or changes to specific data points. The system may then automatically retrieve a set of updated data files corresponding to the data, and may cause the mobile phone to display, via the GUI, the processed data as an updated version of the bar graph based on the updated data files.

In another example, a system may receive one or more sets of loan application data including, e.g., tax, income, and bankruptcy data. The system may first code and generate a set of templates, each template including a set of functions for processing the loan application data. For example, one template may include the functions of aggregate, combine versions, combine evaluations, generate configuration, plot directory, post-process, select columns, and split data. Each of these functions may also include one or more sub-functions for additional processing of the loan application data within each function. Once a set of templates is generated, the system may retrieve a first template appropriate for processing the loan application data and displaying the data as a default graphical representation, e.g., a line graph. The system may then process the data according to the series of functions and sub-functions coded in the first template. The system may cause a computing device, e.g., a laptop, to display, e.g., via a GUI, the loan application data as a line graph. The system may then receive a user selection, e.g., via a dropdown selector displayed on the GUI of the laptop, for displaying the data as a graphical representation different from the default graphical representation, e.g., as a pie chart. The system may then retrieve a second template appropriate for processing the data and displaying the data as a pie chart. The system may then cause the laptop to display, via the GUI, the loan application data as a pie chart instead of as a line graph.

In another example, a system may receive one or more sets of financial data. The system may first code and generate a set of templates, each template including a set of functions for processing the set of financial data. For example, one template may include the functions select columns, combine columns, aggregate, calculate weighted average, filter, transpose, and output. Each of these functions may also include one or more sub-functions for additional processing of the financial data within each function. Once a set of templates is generated, a user may access the system to visualize the data, i.e., to view the data as a graphical representation. For example, a user may use a computing device, e.g., a tablet, to access a financial application. Through the financial application, the user may select a first graphical representation, e.g., a scatter plot, for displaying the data. Once the user has selected the scatter plot via, e.g., a dropdown selector displayed on a GUI of the tablet, the system may receive the user selection and may process the data according to the series of functions and sub-functions coded in a first template. The system may cause the tablet to display, e.g., via a GUI, the financial data as a scatter plot. The system may then receive a second user selection to display the financial data as a second graphical representation different from the first graphical representation, e.g., a bar graph. The system may process the data according to the series of functions and sub-functions coded in a second template. The system may then cause the tablet to display, via the GUI, the financial data as a bar graph instead of as a scatter plot.

1. A system for template-based data visualization, comprising:
one or more processors; and
a memory in communication with the one or more processors and storing instructions that, when executed by the one or more processors, are configured to cause the system to:
receive one or more data sets;
generate a plurality of processing templates, wherein each of the plurality of processing templates comprising a plurality of pre-coded functions;
receive a first user input selecting a first graphical representation for displaying the one or more data sets;
determine a respective accuracy level for each of the plurality of processing templates, the respective accuracy level based on the plurality of pre-coded functions;
retrieve, based on the first user input, a first template of the plurality of processing templates, wherein the first template corresponds to a highest respective accuracy level of the plurality of processing templates;
process the one or more data sets by utilizing the first template;
generate one or more data files corresponding to the one or more processed data sets,
wherein at least one pre-coded function associated with the first template comprises instructions for including one or more types of metadata in the one or more data files, and
wherein the one or more types of metadata comprise an x-axis, a y-axis, a graph type, a graph title, a graph area, or combinations thereof;
cause a computing device to display, via a graphical user interface (GUI), the one or more processed data sets as the first graphical representation based on the one or more data files;
retrieve one or more updated data files corresponding to the one or more processed data sets; and
cause the computing device to display, via the GUI, the one or more processed data sets as a second graphical representation based on the one or more updated data files.

2. The system of claim 1, wherein retrieving the one or more updated data files is based on a request to update the first graphical representation.

3. The system of claim 1, wherein the second graphical representation is an updated version of the first graphical representation which replaces the first graphical representation via the GUI.

4. The system of claim 1, wherein the plurality of pre-coded functions comprise aggregate, combine versions, combine values, select columns, combine columns, generate configuration, plot directory, pre-process, post-process, select source, split data, create subset rows, calculate weighted average, filter, transpose, output, or combinations thereof.

5. The system of claim 1, wherein each of the pre-coded functions comprises one or more pre-coded sub-functions.

6. The system of claim 1, wherein the first graphical representation comprises a bar graph, a line graph, a scatter plot, a chart, a pie chart, a dot plot, or a histogram.

7. The system of claim 1, wherein the one or more data files comprise a comma-separated values file comprising the one or more processed data sets.

8. The system of claim 7, wherein the one or more data files further comprise a directory file to enable grouping of the one or more processed data sets.

9. A system for template-based data visualization, comprising:
one or more processors; and
a memory in communication with the one or more processors and storing instructions that, when executed by the one or more processors, are configured to cause the system to:
receive one or more data sets;
generate a plurality of processing templates, wherein each of the plurality of processing templates comprising a plurality of pre-coded functions;
retrieve a first template of the plurality of processing templates, wherein the first template comprises a default graphical representation for displaying the one or more data sets;
process the one or more data sets by utilizing the first template;
cause a computing device to display, via a GUI, the one or more data sets as the default graphical representation;
receive a first user input selecting a second graphical representation for displaying the one or more data sets;
determine a respective accuracy level for each of the plurality of processing templates;
retrieve, based on the first user input, a second template of the plurality of processing templates, wherein the second template corresponds to a highest respective accuracy level of the plurality of processing templates;
process the one or more data sets by utilizing the second template,
wherein at least one pre-coded function associated with the second template comprises instructions for including one or more types of metadata in the second graphical representation, and
wherein the one or more types of metadata comprise an x-axis, a y-axis, a graph type, a graph title, a graph area, or combinations thereof; and
cause the computing device to display, via the GUI, the one or more data sets as the second graphical representation.

10. The system of claim 9, wherein no code change is required by the system to process the one or more data sets by utilizing the second template or to cause the computing device to display the one or more data sets as the second graphical representation.

11. The system of claim 9, wherein the second graphical representation replaces the default graphical representation via the GUI.

12. The system of claim 9, wherein the instructions are further configured to cause the system to:
retrieve one or more updated data files corresponding to the one or more data sets; and
cause the computing device to display, via the GUI, the one or more data sets as the second graphical representation based on the one or more updated data files.

13. The system of claim 9, wherein the default graphical representation comprises a bar graph, a line graph, a scatter plot, a chart, a pie chart, a dot plot, or a histogram.

14. The system of claim 9, wherein the second graphical representation comprises a bar graph, a line graph, a scatter plot, a chart, a pie chart, a dot plot, or a histogram.

15. The system of claim 9, wherein the second graphical representation is different from the default graphical representation.

16. A non-transitory computer readable medium having stored thereon instructions that when executed by one or more processors cause the one or more processors to:
receive one or more data sets;
generate a plurality of processing templates, wherein each of the plurality of processing templates comprising a plurality of pre-coded functions;
receive a first user input selecting a first graphical representation for displaying the one or more data sets;
determine, based on the first user input, a first respective accuracy level for each of the plurality of processing templates;
process the one or more data sets by utilizing a first template of the plurality of processing templates,
wherein the first template corresponds to a highest first respective accuracy level of the plurality of processing templates, and
wherein at least one pre-coded function associated with the first template comprises first instructions for including one or more first types of metadata in the first graphical representation;
cause a computing device to display, via a GUI, the one or more data sets as the first graphical representation;
receive a second user input selecting a second graphical representation for displaying the one or more data sets;
determine, based on the second user input, a second respective accuracy level for each of the plurality of processing templates;
process the one or more data sets by utilizing a second template of the plurality of processing templates,
wherein the second template corresponds to a highest second respective accuracy level, and
wherein at least one pre-coded function associated with the second template comprises second instructions for including one or more second types of metadata in the second graphical representation; and
cause the computing device to display, via the GUI, the one or more data sets as the second graphical representation.

17. The non-transitory computer readable medium of claim 16, wherein the second graphical representation replaces the first graphical representation via the GUI.

18. (canceled)

19. The non-transitory computer readable medium of claim 16, wherein the instructions further cause the one or more processors to:
retrieve one or more updated data files corresponding to the one or more data sets; and
cause the computing device to display, via the GUI, the one or more data sets as the second graphical representation based on the one or more updated data files.

20. The non-transitory computer readable medium of claim 16, wherein no code change is required to process the one or more data sets by utilizing the first template or the second template, or to cause the computing device to display the one or more data sets as the first graphical representation or the second graphical representation.

21. The system of claim 1, wherein determining the respective accuracy level comprises evaluating a template index to determine how accurately each of the plurality of processing templates may process the one or more data sets and display the one or more data sets as the first graphical representation.
